(19) United States
(12) Patent Application Publication
(10) Pub. No.: US 2005/0123130 A1
(43) Pub. Date: Jun. 9, 2005

(54) Flat panel telephone

(76) Inventor: Michael Wotton, Plantsville, CT (US)

Correspondence Address: NOTARO AND MICHALOS, 100 DUTCH HILL ROAD, SUITE 110, ORANGEBURG, NY, 10962-2100, US

(21) Appl. No.: 10/731,347

(22) Filed: Dec. 9, 2003

(51) Int. Cl. H04M 1/00; H04M 9/00

(52) U.S. Cl. 379/419

(57) ABSTRACT

A flat telephone has a substantially flat panel with a front surface, a rear surface and thin side edges. A plurality of touch sensors are adhered on the front surface of the flat panel. An electronics unit is recessed in the rear surface of the flat panel. A speaker and a microphone are electrically connected to the electronics unit and disposed proximate the front surface of the flat panel. A sleeve having a decorative design covers the flat panel.

### FIELD AND BACKGROUND OF THE INVENTION

The present invention relates generally to the field of telephones and in particular to flat panel telephones.

There are many existing telephone sets with different designs and shapes.

Telephone construction, operation, and design have changed dramatically since the invention of the telephone by Alexander Graham Bell in U.S. Pat. No. 174,465. Early telephones were cumbersome, crank operated and utilized a separate earpiece connected by a cord to a stationary telephone box. The telephone box was mounted on a wall and had a speaker cone with a mouthpiece. In the 1950s, black bulky telephones were in use with a stationary base with a rotatable dial. A movable handset with an earpiece and mouthpiece was connected by a cord to the stationary base. In the 1980s, lighter weight white and colored handsets were developed with pushbuttons between the earpiece and mouthpiece or with pushbuttons on the base. Pushbutton telephones have generally replaced rotary telephones.

Despite the progress in the telephone's operation and structure over the years, conventional telephones are still generally bulky and consume limited available space on flat surfaces, such as desk tops or counter tops, and walls. Particularly, wall-mounted telephones are typically obtrusive since they must protrude at least several inches from a wall. Also, because of their bulk and weight, wall-mounted telephones generally require mounting plates which require forming additional holes in the wall, as well as, additional hardware, i.e., screws, nuts, etc., for securing the mounting plate to the wall.

Moreover, conventional telephones are generally not esthetically attractive or eye-catching. They are not decorative items.

Telephones having flat structures are known in the prior art. For example, U.S. Pat. No. 5,220,598 to Böck discloses a telephone having a flat laminate construction formed of several compressed plastic films. Telephonic parts, including, telephone keys, a microphone, a speaker, and a circuit board, are housed in recesses formed in the laminated film layers.

Also, a combined thin mouse pad and telephone device is disclosed in U.S. Pat. No. 6,061,446 to Lester, et al. The device has a three layer key pad connected to a control unit which is configured as a curved wrist rest. The three layer pad comprises a top Mylar® layer, a middle layer of telephone keys and a bottom non-skid layer. The telephone keys, conventional capacitor touch switches, are adhered to the top surface of the bottom layer. Copper traces connect the telephone keys to a telephone controller stored in the control unit.

It is desirable to provide telephones which have a simpler construction, are lighter in weight, flatter and thinner and which act as a decorative display item. One telephone which seeks to provide some of these features is embodied in a relatively flat, panel telephone sold by Tiger Electronics division of Hasbro, Inc. under the name POSTER PHONE. The Tiger phone has a paper cover over a foam panel in which sensors for the telephone dial numbers and wiring are embedded. The Tiger phone is provided with a housing containing telephone electronics and a speaker extending from the rear of the panel. Several projections are provided around the perimeter of the panel back side so that the panel and housing are supported above a surface, or away from a vertical wall if the phone is wall-mounted. The Tiger phone sensors are not raised buttons, but are substantially flush with the panel below the paper cover.

However, the Tiger phone has some drawbacks including positioning of the telephone speaker to face away from a user, the dial number sensors can be difficult to operate and require successive presses to activate once, and construction requires a method of forming channels for wiring and sensors in the panel. Thus, there is room for improvement over this solution.

### SUMMARY OF THE INVENTION

It is an object of the present invention to provide a light weight, durable telephone having a flat, thin structure.

It is a further object of the present invention to provide a telephone which appears as a decorative item.

It is still further an object of the present invention to provide a telephone with minimal moving parts so that it is not susceptible to easy breakage.

Accordingly, a flat panel telephone is provided comprising a flat panel having a front surface, a rear surface and thin side edges. A plurality of touch sensors are adhered on the front surface of the flat panel. The number of sensors corresponds to the number of telephone dial buttons plus any desired function buttons, such as “#” and “*” buttons, among others. An electrical unit containing a telephone circuit is recessed in the rear surface of the flat panel. A speaker and microphone are disposed proximate the front surface of the flat panel. Wiring connects the touch sensors, speaker and microphone to the electrical unit. A cover covers the flat panel, along with the touch sensors and wiring.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a front perspective view of the telephone of the invention;

FIG. 2 is a front perspective view of the panel and touch sensors of the invention;

FIG. 3 is a front perspective view of the sleeve of the invention;

FIG. 4 is a top perspective view of the panel with a printed pattern of the invention;

FIG. 5 is an exploded top perspective view of the touch sensors adhered to the panel of the invention;

FIG. 6 is a front view of the touch sensor bundles of the invention;

FIG. 7 is a front view of the speaker incorporated in the electronics unit of the invention;

FIG. 8 is a front view of the speaker electrically connected to the electronics unit;

FIG. 9 is a side perspective view of the microphone collar of the invention;

FIG. 10 is a side sectional view of the view of the microphone collar of the invention;

FIG. 11 is a rear perspective view of the telephone of the invention;

FIG. 12 is a side sectional view of the electronics unit of the invention;

FIG. 13 is a front view of the removable cover of the electronics unit of the invention;

FIG. 14 is a side elevational view of the telephone line connection to the telephone of the invention;

FIG. 15 is a front perspective view of the tin overlay of the invention; and

FIG. 16 is a side sectional view of the thin overlay of the invention.

### DESCRIPTION OF THE PREFERRED EMBODIMENTS

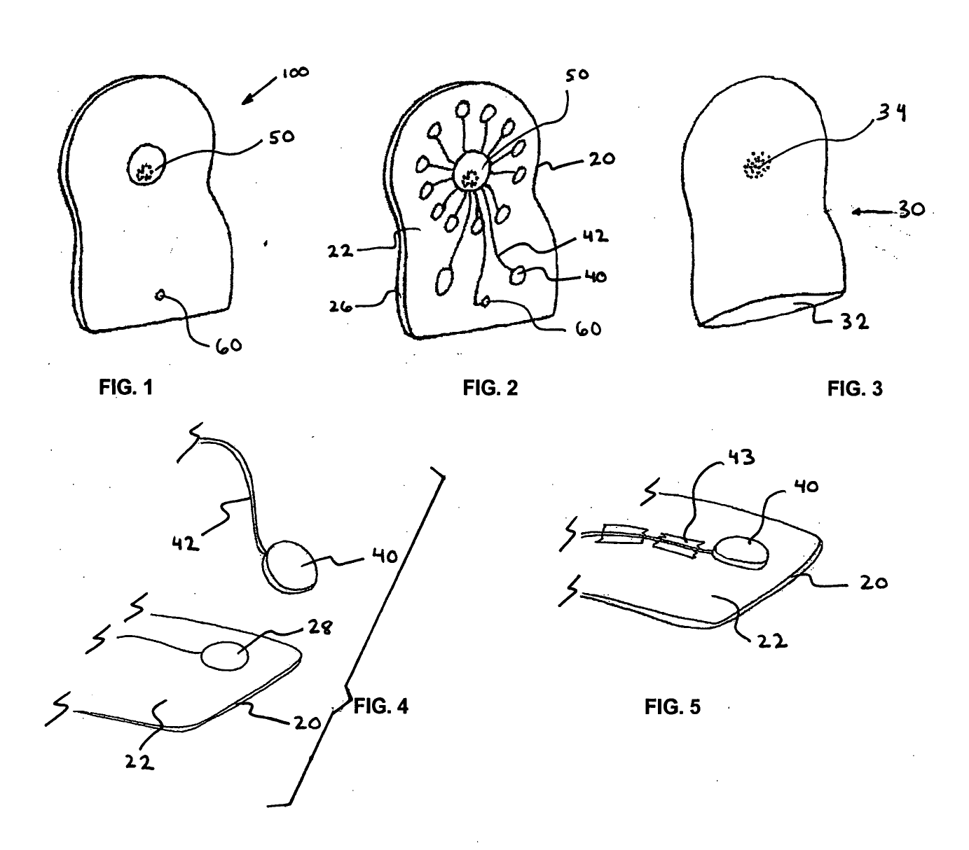

Referring now to the drawings, in which like reference numerals are used to refer to the same or similar elements, FIG. 1 shows a telephone 100 having a flat thin housing 10. The housing 10, as shown in FIG. 2, comprises a panel 20 having a front surface 22, a rear surface 24 and side edges 26. The panel 20 is preferably formed of cardboard, but can also be formed of foam or another rigid substrate capable of supporting the telephone components mounted thereon, as will be described further herein. The substrate should preferably resist bending or breaking when pressed.

The panel preferably has a height ranging from about 6 to 40 inches and a width between about 6 to 30 inches. The thickness of the panel 20 is preferably in the range of 0.125 inches to 1.0 inches. The panel may be of any size, including thinner or thicker as needed for the material forming panel 20, and larger or smaller depending on the sizes and shapes of the components mounted on panel 20. The panel 20 can have a myriad of shapes, such as a bell, rectangle, oval, circle, square, among others. The panel 20 can be shaped to simulate particular objects for decorative effect as well.

Touch sensors 40 and connected wiring 42 are adhered onto the front surface 22 of the panel 20. The touch sensors 40 are preferably conventional pressure sensitive sensors as are known for detecting when pressure is applied. The sensors 40 may be a type having a semi-spherical bubble made wholly or partly of a conducting material positioned over two conducting leads, for example, so that when the bubble is pressed down, the conducting leads are joined and a circuit is completed.

The panel 20 preferably has a printed pattern 28, shown in FIG. 4, on its front surface 22 for guiding the placement of the touch sensors 40 and the wiring 42. Glue is preferably used to adhere the touch sensors 40 and the wiring 42 to the panel 20. However, other adhesion methods can be used, such as double-sided tape 43, as shown in FIG. 5, for attaching the touch sensors 40 and wiring 50 onto the front surface 22 of the panel 20.

A sleeve 30, shown in FIG. 3, covers the panel 20, touch sensors 40 and wiring 42. The sleeve 30 is preferably formed of a soft but durable material, such as vinyl. The sleeve 30 has an opening 32, preferably at its bottom end, for receiving the panel 20. The opening 32 is heat sealed along its edges to encase the panel 20 inside the sleeve 30. A telephone keypad design (not shown) is printed on the sleeve 30. The sleeve 30 preferably has other decorative designs or images, such as art work and/or photographs (not shown), so that the telephone 100 simulates a decorative item, such as artistic wall hanging or a poster. The keypad design can be incorporated as part of the decorative designs or images. The type of decorative designs or images are unlimited and can depend on the location of the telephone 100. For example, the decorative designs can consist of fruits and/or vegetables images if the telephone 100 is displayed in a kitchen, or alternatively, a toy design if the telephone is displayed in a child's room.

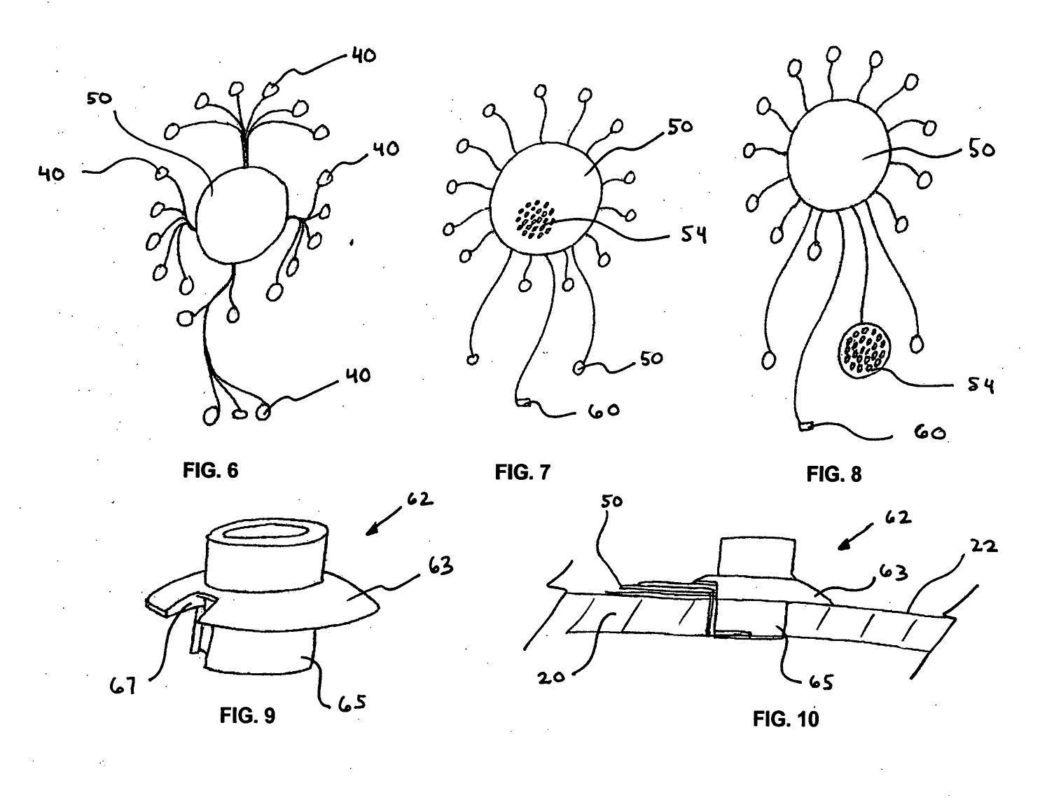

The touch sensors 40 are preferably arranged in fanciful patterns, as shown in FIG. 6. The fanciful patterns correspond with the keypad design and/or other decorative designs displayed on the sleeve 30.

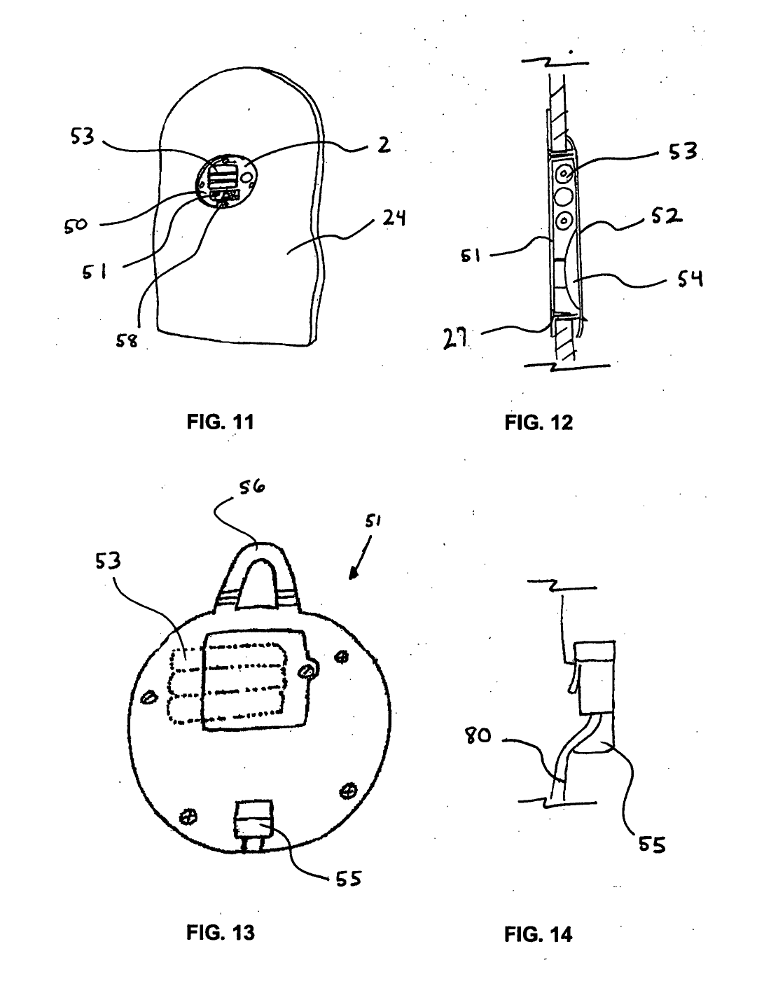

An electronics unit 50 is supported in an opening 27 preferably formed in the rear surface 24 of the panel 20, as shown in FIG. 11. The electronics unit 50 has a removable cover 51, shown in FIG. 13, which is flush with the rear surface 24 of the panel 20 and a front wall 52 which projects through the front surface 22 of the panel 20. The removable cover 51 is attached to the electronics unit 50 by conventional fasteners, preferably screws. The removable cover 51 also has a recess 55 for receiving a telephone line 80, shown in FIG. 11. The recess 55 allows the telephone line 80 to lay flush against the wall.

A conventional electronic circuit 51 used for telephone communications, illustrated in FIG. 11, is housed in the electronics unit 50. The electronic circuit 51 can include “DTMF” or touch-tone dialing capability to send and receive voice communications via telephone wire. It is envisioned as well that the electronic circuit 51 could be enabled for wireless communications such as cellular telephone transmissions, Wi-Fi or Bluetooth.

The electronic circuit 51 is preferably a powered circuit receiving power from a power source 53. The power source is preferably batteries, but other AC or DC sources can be used instead with appropriate conversion for use with the circuit 51. Alternately, the electronic circuit 51 can be powered like a conventional telephone directly from the telephone wires. A conventional jack 58 is electrically connected to electronic circuit 51.

A conventional speaker 54, shown in FIG. 12, is housed inside the electronics unit 50. The speaker 54 is electrically connected to the electronic circuit 51 and an integral part of the electronics unit 50. The electronics unit 50 may have one or more sound holes, as illustrated in FIG. 7, for permitting the speaker 54 to function normally, while protecting the speaker from external damage. The speaker 54 projects through one or more openings in the sleeve 30. For example, the sleeve 30 can have a plurality of pin holes 34, as shown in FIG. 3, which correspond with the speaker 54 and openings in electronics unit 50 to allow sounds to exit unmuffled from the speaker 54.

In another embodiment, as illustrated in FIG. 8, the speaker 54 extends from the electronics unit 50 via a wire 42. In this embodiment, the speaker 54 is placed at a location which is closer to the user than the electronics unit 50.

The speaker 54 can be secured to the panel 20 using grommets through the panel 20 and/or other fasteners, such as threaded fasteners, clips, etc.

Preferably, the speaker is supported in a frame having a protective cover over the diaphragm to prevent possible puncture or unintended deformation. The frame may have pin holes like those of the electronics unit 50, and the sleeve 30 can have corresponding openings in the same manner as well. When the speaker 54 is not integral with the electronics unit 50, the rear of the speaker can be mounted through an opening in the panel 20 to reduce the protrusion of the speaker 54 from the panel 20 and protect the speaker 54 components. The speaker frame cover can be mounted to the panel 20 using fasteners as described above to secure the speaker 54 in place.

Using either speaker mounting, the phone 100 remains relatively thin and flat, while providing undistorted sound to the user.

A conventional microphone 60 projects through the front surface 22 of the panel 20 and the sleeve 30. The microphone 60 connects to the electronic circuit 51 via wiring 42. A collar 62, illustrated in FIGS. 9 and 10, supports the microphone 60 on the panel 20. The collar has a flange 63 which rests on the front surface 22 of the panel 20 and a post 65 which extends into the panel 20. A groove 67 for receiving the wiring 50 extends longitudinally through the flange 63 and the post 65. The groove 67 allows the wiring 50 to exit the microphone 60 flush with the front surface 22 of the panel 20.

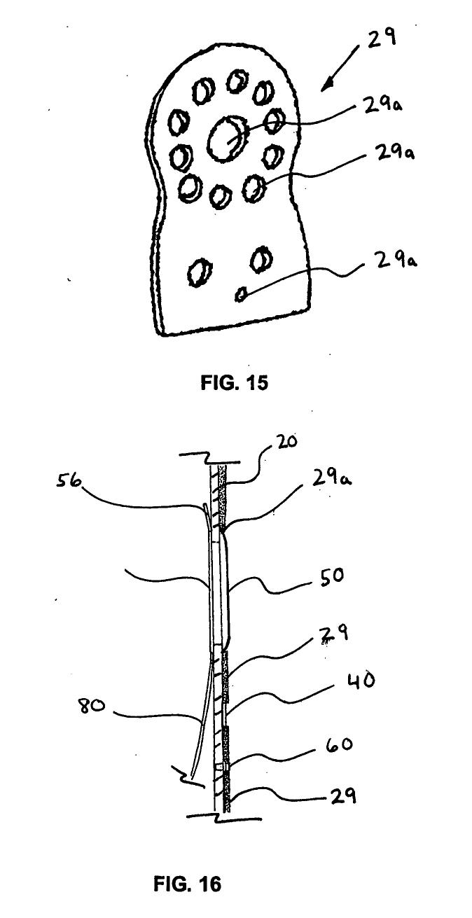

In another embodiment, a thin overlay 29, as shown in FIGS. 15 and 16, is adhered by conventional means to the front surface 22 of the panel to provide additional depth to the housing 10. The thin layer 29 is preferably formed of foam and has openings 29a for receiving the touch sensors 40, the speaker 52 and the microphone 60.

The telephone 100 can be placed on a flat surface, such as a desk, or hung on a wall. The telephone 100 presents a substantially flat support surface when mounted, so that the panel 20 is not bent or deformed during use, thereby making operation of the sensors 40 easier and more reliable. The removable cover 51 has a hinge 56, preferably a pivoting hinge, for mounting the telephone 100 onto a wall.

While a specific embodiment of the invention has been shown and described in detail to illustrate the application of the principles of the invention, it will be understood that the invention may be embodied otherwise without departing from such principles.

1. A flat telephone comprising:
a flat panel having a front surface, a rear surface and thin side edges;
a plurality of touch sensors adhered on the front surface of the flat panel;
an electronics unit recessed in the flat panel;
a speaker electrically connected to the electronics unit and disposed proximate the front surface of the flat panel;
a microphone electrically connected to the electronics unit and disposed proximate the front surface of the flat panel; and
a means for covering the flat panel.

2. The flat telephone as claimed in claim 1, wherein the means for covering is a sleeve.

3. The flat telephone as claimed in claim 2, wherein the sleeve is made of vinyl.

4. The flat telephone as claimed in claim 1, wherein the panel is made of foam or cardboard.

5. The flat telephone as claimed in claim 2, wherein the sleeve has a decorative design.

6. The flat telephone as claimed in claim 2, wherein the sleeve has a keypad.

7. The flat telephone as claimed in claim 1, further comprising a means for mounting the flat telephone onto a wall.

8. The flat telephone as claimed in claim 1, wherein the electronics unit has a removable cover.

9. The flat telephone as claimed in claim 1, wherein the touch sensors are glued onto the front surface of the flat panel.

10. The flat telephone as claimed in claim 1, wherein the front surface of the flat panel has a printed pattern for guiding the placement of the touch sensors.

11. The flat telephone as claimed in claim 6, wherein the touch sensors correspond with the decorative design on the sleeve.

12. The flat telephone as claimed in claim 2, wherein the sleeve has an opening for accommodating the speaker.

13. The flat telephone as claimed in claim 1, wherein the electronics unit has a telephone jack for connecting a telephone line.

14. The flat telephone as claimed in claim 1, further comprising a thin board mounted onto the front surface of the panel, the thin board having openings which accommodate the speaker and touch sensors.

15. The flat telephone as claimed in claim 1, wherein the speaker is housed inside the electronics unit.

16. The flat telephone as claimed in claim 1, further comprising a collar for supporting the microphone on the front surface of the panel, the collar having a flange which rests on the front surface of the panel, a post which extends down from the flange into an opening in the panel and a groove disposed along adjacent areas of the flange and post for accommodating a wire.

17. The flat telephone as claimed in claim 1, wherein the touch sensors are arranged in different bundles electrically connected to the electronics unit.

18. A flat telephone comprising:
a flat panel having a front surface, a rear surface and thin side edges;
a plurality of touch sensors adhered on the front surface of the flat panel;
an electronics unit recessed in the flat panel;
a speaker electrically connected to the electronics unit and disposed proximate the front surface of the flat panel;
a microphone electrically connected to the electronics unit and disposed proximate the front surface of the flat panel;
a means for hanging the flat telephone on the wall; and
a sleeve which covers the flat panel, the sleeve having a keypad design and a decorative design.

19. The flat telephone as claimed in claim 18, wherein the touch sensors correspond with the decorative design on the sleeve.

20. A flat telephone comprising:
a flat panel having a front surface, a rear surface and thin side edges;
a plurality of touch sensors adhered on the front surface of the flat panel;
an electronics unit recessed in the flat panel;
a speaker electrically connected to the electronics unit and disposed proximate the front surface of the flat panel;
a microphone electrically connected to the electronics unit and disposed proximate the front surface of the flat panel; and
a sleeve which covers the flat panel, the sleeve having a decorative design.
